(19) United States
(12) Patent Application Publication
(10) Pub. No.: US 2017/0234703 A1
(43) Pub. Date: Aug. 17, 2017

(54) POSITION SENSOR

(71) Applicant: Continental Teves AG & Co. oHG, Frankfurt (DE)

(72) Inventor: Heinrich Acker, Schwalbach (DE)

(21) Appl. No.: 15/503,241

(22) PCT Filed: Sep. 22, 2015
(86) PCT No.: PCT/EP2015/071703

§ 371 Date: Feb. 10, 2017

(30) Foreign Application Priority Data
Sep. 22, 2014 (DE) 10 2014 219 009.6

(51) Int. Cl. G01D 5/20

(52) U.S. Cl. CPC G01D 5/2046

(57) ABSTRACT

A position sensor for sensing a position of a magnetic object, including: a planar coil; a magnetizable element which covers at least part of the planar coil and can be magnetized by the magnetic object, whereby an impedance of the planar coil can be varied; and a processor for determining the position of the magnetic object in accordance with the impedance for the planar coil.

### CROSS REFERENCE TO RELATED APPLICATIONS

This application is the U.S. National Phase Application of PCT International Application No. PCT/EP2015/071703 filed Sep. 22, 2015, which claims priority to German Patent Application No. 10 2014 219 009.6, filed Sep. 22, 2014, the contents of such applications being incorporated by reference herein.

### FIELD OF THE INVENTION

The present invention relates to a position sensor.

### BACKGROUND OF THE INVENTION

A brake system of a motor vehicle often comprises a tandem master cylinder in which a piston connected to a brake pedal of the brake system is arranged. Since a pedal travel of the brake pedal can be detected by detecting the position of the piston, a position sensor for detecting the position of the piston is often integrated in the tandem master cylinder. Since the tandem master cylinder often comprises a metal housing, for example an aluminum housing, it is difficult to detect the position of the piston by means of a position sensor arranged outside the tandem cylinder.

A linear inductive position sensor (LIPS) is often used to detect the position of the piston. This sensor often comprises a differential transformer having a primary coil and two secondary coils. Measuring coils which are wound in a complicated and cost-intensive manner are often used as the primary coil and secondary coils. Furthermore, when using a metal housing, it may be difficult to detect the position of the piston by means of alternating electrical or magnetic fields as a result of a high conductivity of the metal housing, in particular in the case of an aluminum housing. Complicated and cost-intensive electronics are also often used to evaluate the linear inductive position sensor. Furthermore, the linear inductive position sensor often comprises a differential transformer core which is often produced from a cost-intensive core material.

### SUMMARY OF THE INVENTION

An aspect of the invention is to specify a more efficient and more cost-effective position sensor.

According to one aspect of the invention, a position sensor for detecting a position of a magnetic object is provided, the position sensor having: a planar coil; a magnetizable element which at least partially covers the planar coil and can be magnetized by means of the magnetic object, as a result of which an impedance of the planar coil can be changed; and a processor for determining the position of the magnetic object on the basis of the impedance of the planar coil. This achieves the advantage that the position of the magnetic object can be efficiently detected.

The magnetic object may be integrated in a piston which is an element of a brake system. For example, the piston is accommodated in a tandem master cylinder of the brake system and is connected to a brake pedal. In this case, the position of the piston can be determined by detecting the position of the magnetic object. Furthermore, a distance covered by the magnetic object, such as a pedal travel of the brake pedal, a direction of movement, in particular an angle of a movement, of the magnetic object, a speed of the magnetic object and/or an acceleration of the magnetic object can be determined on the basis of the detected position of the magnetic object, for example by means of the processor. Furthermore, the position sensor may form a tripping element of a brake light switch or may be included in a brake light controller.

The planar coil may be arranged on a printed circuit board. For example, the printed circuit board has a copper coating from which the planar coil was formed by means of an etching process. Furthermore, the planar coil can have a meandering shape, a rectangular shape, a trapezoidal shape or a triangular shape. In this case, the planar coil can have rounded corners.

The magnetizable element may comprise a flat ferromagnetic element. Furthermore, the magnetizable element may be arranged on the planar coil, in particular between the planar coil and the magnetic object. The planar coil may also be arranged between the magnetizable element and the magnetic object. Furthermore, the magnetizable element may at least partially surround the planar coil. According to one embodiment, the position sensor may comprise a further magnetizable element, the planar coil being arranged between the magnetizable element and the further magnetizable element. Furthermore, the magnetizable element and/or the further magnetizable element may be soldered and/or adhesively bonded to the printed circuit board on which the planar coil is arranged.

The processor may be designed to detect a resistance and/or a reactance of the planar coil. The processor may also comprise a device for detecting the resistance and/or the reactance of the planar coil, a Maxwell bridge circuit and/or a Maxwell-Wien bridge circuit. The processor may also comprise a capacitor and may be designed to detect a resonant frequency of a resonant circuit formed by the planar coil and the capacitor and to determine the impedance of the planar coil on the basis of the resonant frequency and a capacitance of the capacitor.

For example, the impedance of the planar coil is determined according to the following formulae:

Z=R+jX;

X=ωL; and

ω=2nf;

where Z denotes the impedance of the planar coil, R denotes the detected resistance of the planar coil, X denotes the detected reactance of the planar coil, w denotes an angular frequency and f denotes a frequency. In this case, the impedance of the planar coil is a complex variable.

According to one embodiment, both the reactance of the planar coil and the resistance of the planar coil may depend on the position of the magnetic object since all losses, for example caused by eddy current, can contribute to the resistance of the planar coil, not only the DC resistance of the planar coil. Furthermore, the inductance of the planar coil can be determined from the impedance of the planar coil, which is why the detection of the impedance of the planar coil is often referred to as an inductance measurement.

The processor may also comprise a microcontroller or may be formed by a microcontroller. Furthermore, the position sensor may comprise a memory in which calibration data are prestored, in particular in the form of a look-up table. The processor may also be designed to determine the position of the magnetic object on the basis of the impedance and the calibration data.

The magnetizable element may form a coil core of the planar coil. Therefore, the impedance of the planar coil can be changed by changing the magnetic properties of the magnetizable element. If the magnetic object is close to the magnetizable element, at least partial magnetic saturation of the magnetizable element may be caused by the magnetic field of the magnetic object. The change in the impedance of the planar coil caused thereby can be detected by means of the processor. For example, the change in the impedance of the planar coil as a result of the at least partial magnetic saturation of the magnetizable element is 5%, 10%, 15%, 20%, 25%, 30%, 35%, 40%, 45%, 50%, 55% or 60%. In this case, the change in the impedance of the planar coil as a result of the at least partial magnetization of the magnetizable element may be dependent on the position of the magnetic object, in particular dependent on the distance between the magnetic object and the magnetizable element. This makes it possible to determine the position of the magnetic object by means of the calibration data. For this purpose, a position of the magnetic object is assigned to an impedance of the planar coil in the calibration data, for example.

In one advantageous embodiment, the magnetizable element is arranged between the planar coil and the magnetic object. This achieves the advantage that the magnetizable element can be efficiently magnetized.

In another advantageous embodiment, the planar coil has a meandering shape, a rectangular shape, a trapezoidal shape or a triangular shape. This achieves the advantage that an efficient planar coil can be used.

In another advantageous embodiment, the planar coil is arranged on a printed circuit board.

This achieves the advantage that the planar coil can be produced in a particularly cost-effective manner.

Furthermore, the planar coil arranged on the printed circuit board and the magnetizable element may form a base element or may be included in a base element. In another advantageous embodiment, the magnetizable element is arranged on the printed circuit board, in particular is soldered or adhesively bonded. This achieves the advantage that the magnetizable element can be efficiently mechanically fixed to the planar coil.

In another advantageous embodiment, the processor is designed to detect a resistance or a reactance of the planar coil. This achieves the advantage that the impedance can be efficiently detected.

In another advantageous embodiment, the magnetizable element comprises a ferromagnetic portion. This achieves the advantage that the magnetizable element can be efficiently magnetized.

Furthermore, the magnetizable element may comprise a ferromagnetic portion and/or a paramagnetic portion. On account of the high magnetic permeability of ferromagnets, the magnetizable element preferably comprises a ferromagnetic portion.

In another advantageous embodiment, the magnetizable element comprises ferrite, steel, transformer laminate or a highly permeable alloy. This achieves the advantage that the magnetizable element can be produced in a particularly cost-effective manner. For example, the highly permeable alloy is an iron alloy, a nickel alloy or a cobalt alloy.

In another advantageous embodiment, the magnetizable element has a rectangular shape, a trapezoidal shape or a triangular shape. This achieves the advantage that the magnetizable element can be formed by a particularly cost-effective stamped part.

In another advantageous embodiment, the position sensor is designed with an insulation element which is arranged between the planar coil and the magnetizable element in order to electrically insulate the planar coil and the magnetizable element from one another. This achieves the advantage that the magnetizable element can be arranged particularly close to the planar coil in order to increase a detection accuracy of the position sensor.

In another advantageous embodiment, the position sensor is designed with a number of distributed magnetizable elements arranged in a row on the planar coil, a distance between two adjacent magnetizable elements of the number of distributed magnetizable elements increasing or decreasing along the row. This achieves the advantage that a movement of the magnetic object in the direction of the row can be efficiently detected.

For example, the number is 2, 3, 4, 5, 6, 7, 8, 9 or 10. Furthermore, the magnetizable elements of the number of distributed magnetizable elements may each be arranged at a distance from one another.

Furthermore, the magnetizable elements of the number of distributed magnetizable elements may be arranged in a structured manner, in particular in the form of a pattern. For example, the pattern is a chessboard pattern or a two-dimensional, in particular an oblique-angled, a right-angled, a centered right-angled, a hexagonal or a square Bravais lattice.

In another advantageous embodiment, the position sensor is designed with a first number of distributed magnetizable elements arranged in a first row on the planar coil and a second number of distributed magnetizable elements arranged in a second row on the planar coil, the first row being shifted with respect to the second row. This achieves the advantage that eddy currents induced in the magnetizable elements can be reduced.

In another advantageous embodiment, the position sensor is designed with a number of distributed magnetizable elements arranged in a row on the planar coil, a length or a width of the magnetizable elements of the number of distributed magnetizable elements increasing or decreasing along the row. This achieves the advantage that an accuracy of the detection of the position of the magnetic object can be increased.

For example, the number is 2, 3, 4, 5, 6, 7, 8, 9 or 10. Furthermore, the magnetizable elements of the number of distributed magnetizable elements may each be arranged at a distance from one another.

In another advantageous embodiment, the position sensor is designed with a number of distributed magnetizable elements arranged in a row on the planar coil, the magnetizable elements of the number of distributed magnetizable elements being mechanically connected to one another by means of a web. This achieves the advantage that a vibration strength of the position sensor can be increased.

For example, the number is 2, 3, 4, 5, 6, 7, 8, 9 or 10. Furthermore, the magnetizable elements of the number of distributed magnetizable elements may each be arranged at a distance from one another. Furthermore, the number of distributed magnetizable elements, in which case the magnetizable elements of the number of distributed magnetizable elements are mechanically connected to one another by means of a web, can be produced by punching out the clearances between the distributed magnetizable elements from a workpiece, such as a transformer laminate.

In another advantageous embodiment, the position sensor is designed with a number of distributed magnetizable elements arranged in a row on the planar coil, the number of distributed magnetizable elements being arranged on a carrier film. This achieves the advantage that the position sensor can be produced in a particularly cost-effective manner.

For example, the number is 2, 3, 4, 5, 6, 7, 8, 9 or 10. Furthermore, the magnetizable elements of the number of distributed magnetizable elements may each be arranged at a distance from one another.

In another advantageous embodiment, the processor is also designed to determine the position of the magnetic object on the basis of an eddy current loss value of the planar coil. This achieves the advantage that an accuracy of the detection of the position of the magnetic object can be increased.

### BRIEF DESCRIPTION OF THE DRAWINGS

Exemplary embodiments of the invention are illustrated in the drawings and are described in more detail below.

In the drawings:

FIG. 1 shows a schematic illustration of a position sensor for detecting a position of a magnetic object according to one embodiment;

FIG. 2 shows a sectional view of a base element for detecting the position of the magnetic object;

FIG. 3 shows a plan view of a base element for detecting the position of the magnetic object according to one embodiment; and

FIG. 4 shows a plan view of a base element for detecting the position of the magnetic object according to another embodiment.

### DETAILED DESCRIPTION OF THE PREFERRED EMBODIMENTS

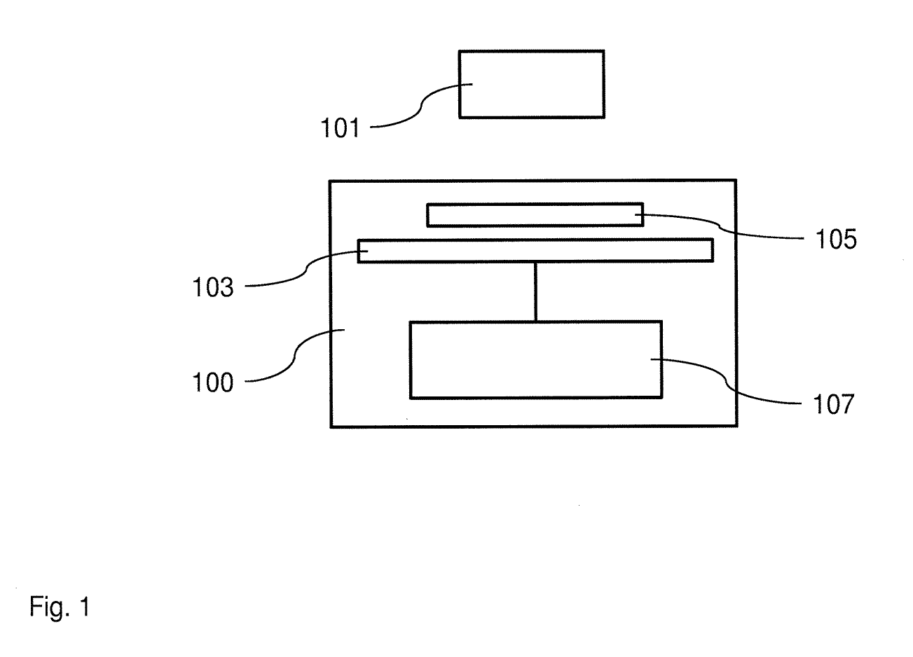

FIG. 1 shows a schematic illustration of a position sensor 100 for detecting a position of a magnetic object 101 according to one embodiment. The position sensor 100 comprises a planar coil 103, a magnetizable element 105 which partially covers the planar coil 103, and a processor 107.

The position sensor 100 for detecting the position of the magnetic object 101 may be designed with: the planar coil 103; the magnetizable element 105 which at least partially covers the planar coil 103 and can be magnetized by means of the magnetic object 101, as a result of which an impedance of the planar coil 103 can be changed; and the processor 107 for determining the position of the magnetic object 101 on the basis of the impedance of the planar coil 103.

The magnetic object 101 may be integrated in a piston which is an element of a brake system. For example, the piston is accommodated in a tandem master cylinder of the brake system and is connected to a brake pedal. In this case, the position of the piston can be determined by detecting the position of the magnetic object 101. Furthermore, a distance covered by the magnetic object 101, such as a pedal travel of the brake pedal, a direction of movement, in particular an angle of a movement, of the magnetic object 101, a speed of the magnetic object 101 and/or an acceleration of the magnetic object 101 can be determined on the basis of the detected position of the magnetic object 101, for example by means of the processor 107. Furthermore, the position sensor 100 may form a tripping element of a brake light switch or may be included in a brake light controller.

The planar coil 103 may be arranged on a printed circuit board. For example, the printed circuit board has a copper coating from which the planar coil 103 was formed by means of an etching process. Furthermore, the planar coil 103 may have a meandering shape, a rectangular shape, a trapezoidal shape or a triangular shape. In this case, the planar coil 103 may have rounded corners.

The magnetizable element 105 may comprise a flat ferromagnetic element. Furthermore, the magnetizable element 105 may be arranged on the planar coil 103, in particular between the planar coil 103 and the magnetic object 101. The planar coil 103 may also be arranged between the magnetizable element 105 and the magnetic object 101. Furthermore, the magnetizable element 105 may at least partially surround the planar coil 103. According to one embodiment, the position sensor 100 may comprise a further magnetizable element, the planar coil 103 being arranged between the magnetizable element 105 and the further magnetizable element. Furthermore, the magnetizable element 105 and/or the further magnetizable element may be soldered and/or adhesively bonded to the printed circuit board on which the planar coil 103 is arranged.

The processor 107 may be designed to detect a resistance and/or a reactance of the planar coil 103. The processor 107 may also comprise a device for detecting the resistance and/or the reactance of the planar coil 103, a Maxwell bridge circuit and/or a Maxwell-Wien bridge circuit. The processor 107 may also comprise a capacitor and may be designed to detect a resonant frequency of a resonant circuit formed by the planar coil 103 and the capacitor and to determine the impedance of the planar coil 103 on the basis of the resonant frequency and a capacitance of the capacitor.

For example, the impedance of the planar coil 103 is determined according to the following formulae:

Z=R+jX;

X=ωL; and

ω=2nf;

where Z denotes the impedance of the planar coil 103, R denotes the detected resistance of the planar coil 103, X denotes the detected reactance of the planar coil 103, co denotes an angular frequency and f denotes a frequency. In this case, the impedance of the planar coil 103 is a complex variable.

According to one embodiment, both the reactance of the planar coil 103 and the resistance of the planar coil 103 may depend on the position of the magnetic object 101 since all losses, for example caused by eddy current, can contribute to the resistance of the planar coil 103, not only the DC resistance of the planar coil 103. Furthermore, the inductance of the planar coil 103 can be determined from the impedance of the planar coil 103, which is why the detection of the impedance of the planar coil 103 is often referred to as an inductance measurement.

The processor 107 may also comprise a microcontroller or may be formed by a microcontroller. Furthermore, the position sensor 100 may comprise a memory in which calibration data are prestored, in particular in the form of a look-up table. The processor 107 may also be designed to determine the position of the magnetic object 101 on the basis of the impedance and the calibration data.

The magnetizable element 105 may form a coil core of the planar coil 103. Therefore, the impedance of the planar coil 103 can be changed by changing the magnetic properties of the magnetizable element 105. If the magnetic object 101 is close to the magnetizable element 105, at least partial magnetic saturation of the magnetizable element 105 may be caused by the magnetic field of the magnetic object 101. The change in the impedance of the planar coil 103 caused thereby can be detected by means of the processor 107. For example, the change in the impedance of the planar coil 103 as a result of the at least partial magnetic saturation of the magnetizable element 105 is 5%, 10%, 15%, 20%, 25%, 30%, 35%, 40%, 45%, 50%, 55% or 60%. In this case, the change in the impedance of the planar coil 103 as a result of the at least partial magnetization of the magnetizable element 105 may be dependent on the position of the magnetic object 101, in particular dependent on the distance between the magnetic object 101 and the magnetizable element 105. This makes it possible to determine the position of the magnetic object 101 by means of the calibration data. For this purpose, a position of the magnetic object 101 is assigned to an impedance of the planar coil 103 in the calibration data, for example.

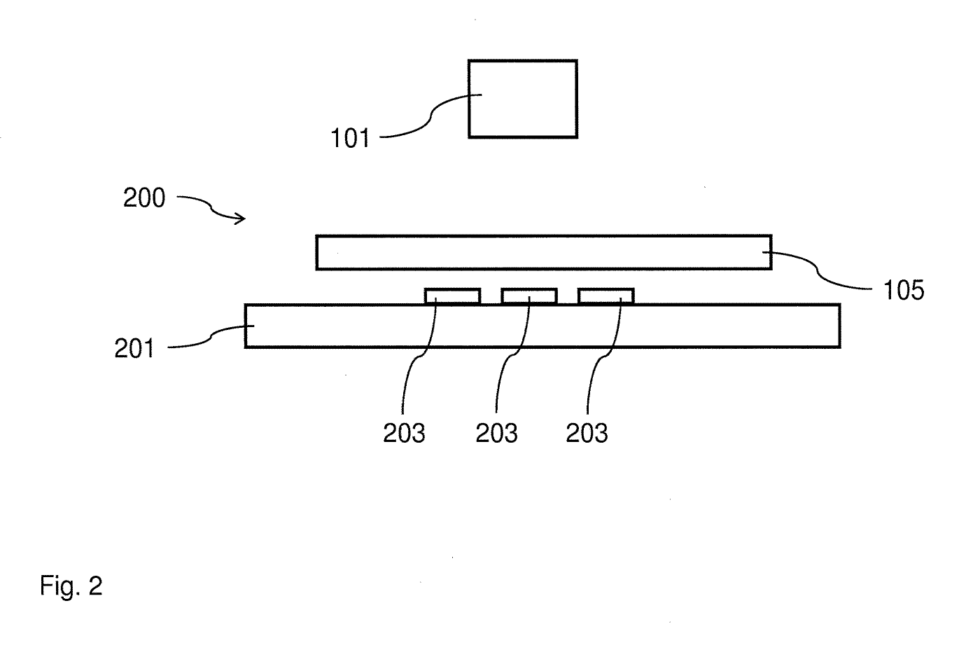

FIG. 2 shows a sectional view of a base element 200 for detecting the position of the magnetic object 101. The base element 200 comprises a printed circuit board 201 having conductor tracks 203 which form a planar coil 103, and a magnetizable element 105.

The planar coil 103 is arranged on the printed circuit board 201. This makes it possible to achieve a cost advantage over wound coils provided that the number of turns of the planar coil 103 is small. Furthermore, low geometric tolerances can be achieved in a process of producing the planar coils 103, which is particularly advantageous for sensor coils.

The basic function of the position sensor 100 or an angle sensor can be produced by

1. arranging a plurality of base elements 200 beside one another and/or in different conductor layers, in particular on a further printed circuit board, and/or

2. adapting the layout of the base element(s) 200 to the path of the magnetic object 101, such as a magnet, for example elongated or compact, straight or curved, angular or round, and/or

3. varying the coverage of the individual parts of the base element 200, and/or

4. combining a plurality of base elements 200 to form a single inductance in the electrical sense by connecting them in series and/or in parallel, and/or

5. individually measuring a plurality of such inductances produced by being connected in series and/or in parallel or elementary inductances, the position or angle information resulting from computational combination of the individual measurement results.

According to one embodiment, a plurality of base elements 200 can be combined in order to form a combined base element.

The base element 200 which comprises the magnetizable element 105, such as a ferromagnetic body, the printed circuit board 201 and conductor tracks 203, which are placed on the latter and form or shape the planar coil 103, can be seen in section in FIG. 2. According to one embodiment, the printed circuit board 201 may be formed by a carrier. According to another embodiment, the magnetizable element 105 can be formed by a ferromagnetic and/or flux-conducting body.

The magnetic object 101, such as a position magnet, is depicted above the base element 200 but conceptually does not belong to the base element 200 since many base elements 200 generally oppose only one magnetic object 101, such as a magnet, even though arrangements containing a plurality of magnetic objects 101 or magnets are likewise possible.

The method of operation is as follows: the conductor tracks 203 produce, in their environment, a magnetic flux, the profile of which depends on the course of the conductor tracks 203. The magnetizable element 105, such as a ferromagnetic body, may be arranged and shaped in such a manner that it is at least partially in the region of this magnetic flux. As a result, the magnetic flux can be predominantly guided through the magnetizable element 105, such as a ferromagnetic body. In this case, an inductance of the planar coil 103 may be higher than without the magnetizable element 105, such as the ferromagnetic body. The influence of the magnetizable element 105, such as the ferromagnetic body, on the inductance of the planar coil 103 may depend on its shape, arrangement and permeability. In the present case, the magnetizable element 105 or the ferromagnetic body is firmly mounted on the printed circuit board 201 and therefore on the planar coil 103 and does not move relative to them. Instead, the magnetic object 101 or the magnet moves and likewise guides flux through the magnetizable element 105, such as the ferromagnetic body.

This element is entirely or partially saturated thereby, as a result of which its permeability and therefore its ability to conduct the flux of the planar coil 103 can fall. This can be measured as a change in the inductance of the planar coil 103.

According to one embodiment, a cost reduction can be achieved by means of a planar arrangement of the base element 200. The conductor tracks 203 can run in one or more parallel layers and may be integrated in a planar carrier, such as the printed circuit board 201. The magnetizable element 105, such as a ferromagnetic body, may be in the form of a sheet or film which can be fastened on the printed circuit board 201 in a plane-parallel manner with respect to the latter, for example by means of soldering or adhesive bonding.

The magnetizable element 105, such as a ferromagnetic body, may have a geometric structure combined from individual parts for the base elements 200 from FIG. 2. This structure is produced by means of stamping or etching, for example. In this case, the procedure is preferably such that this combination produces only one component, that is to say all parts required for the base elements 200 from FIG. 2 are connected, as a result of which assembly can be simplified because only one component is placed and the relative position of the parts can already be determined by the structuring process. In this case, webs may be left behind between the individual parts, which webs can be configured to be so thin that they conduct only little magnetic flux and the function, for example of the base element 200, is therefore influenced only slightly by the webs. According to one embodiment, it is possible to use a non-ferromagnetic carrier film which fixes the parts with respect to one another even though there are no webs.

The electrical conductivity of the material may also be important for the function of the position sensor 100. If the material of the magnetizable element 105, such as a ferromagnetic body, is conductive, an eddy current can also flow there. This eddy current can attenuate the field of the planar coil 103, such as the measuring coils, and is therefore undesirable. However, it can be experimentally proven that good results can be achieved even with simple rolled steel as the magnetizable element 105, such as a ferromagnetic body. In this case, the desired effect may surpass the undesirable effect. In order to improve the performance, it is possible to use other materials, as a result of which the production costs of the position sensor 100 may possibly be increased. Transformer laminate which, among steels, has particularly low conductivity on account of its alloyed silicon may first of all be possible. Furthermore, amorphous and nanocrystalline magnetic functional materials which have particularly high permeabilities may be suitable. Films in which ferrite is embedded on or in a plastic carrier may also exhibit a sensory effect. On account of the low effective permeability of such films, however, this effect may be lower than in the case of the above-mentioned materials. An ideal material with respect to the magnetic properties may be given by soft-magnetic, sintered ferrite. However, since the material is preferably in the form of a thin layer and the production technology may be particularly advantageous with an extended component, processing may be difficult as a result of the brittleness of these materials, in particular as a result of the risk of fracture. If appropriate, the combination of carrier film and small ferrite bodies may be attractive, but manufacturing challenges may then also arise which are possibly not present in the case of steel.

The magnetizable element 105, such as a ferromagnetic body, may preferably be very thin so that it can also be effectively saturated by the magnetic object 101, such as a magnet, or an overly large magnetic object 101, such as an overly large magnet, is not required or the distance between the position sensor 100 and the magnetic object 101, such as the magnet, is not too short. In this case, “thin” may mean that good results can be achieved with a rolled steel film having a thickness of 0.025 mm. Furthermore, with a thin steel film, it may be advantageous that the eddy currents flowing in the plane of the film are lower than in the case of a thick layer.

In comparison with the known LIPS, the position sensor 100 may also have the further cost advantage that a transformer measurement is replaced with a measurement of the inductance of the planar coil 103. It is therefore possible to dispense with a winding, such as a primary coil, for exciting the LIPS system. Furthermore, redundancy can be improved since each measuring channel is now independent, whereas, in the case of a LIPS system, failure of a primary coil can result in complete failure of the LIPS system.

With regard to the eddy current, it can be stated that the position sensor 100 may not only have a characteristic curve in the inductance but also a characteristic curve, such as a dependence of the measurement variable, in the losses caused by eddy current. Therefore, the measurement of the losses may likewise be used to determine the measurement variable of position or angle. However, targeted production of such a characteristic curve may be difficult as a result of the entire arrangement being optimized to a characteristic curve which is as good as possible in the inductance. Nevertheless, improvements may result from additionally measuring the eddy current losses. If a processor 107 which, in addition to the impedance, can also detect the eddy current losses is used, it is possible to check, for each individual arrangement, at least after optimization, whether usable results can be achieved.

According to one embodiment, a magnetizable element 105, such as a ferromagnetic part, may be arranged on both sides of the printed circuit board 201 and therefore of the planar coil 103. The sensory effect can be intensified by using magnetizable elements 105, such as ferromagnetic parts, in two planes, above and below the printed circuit board 201. In this case, the same layout can be used on both sides. Furthermore, different layouts can be used.

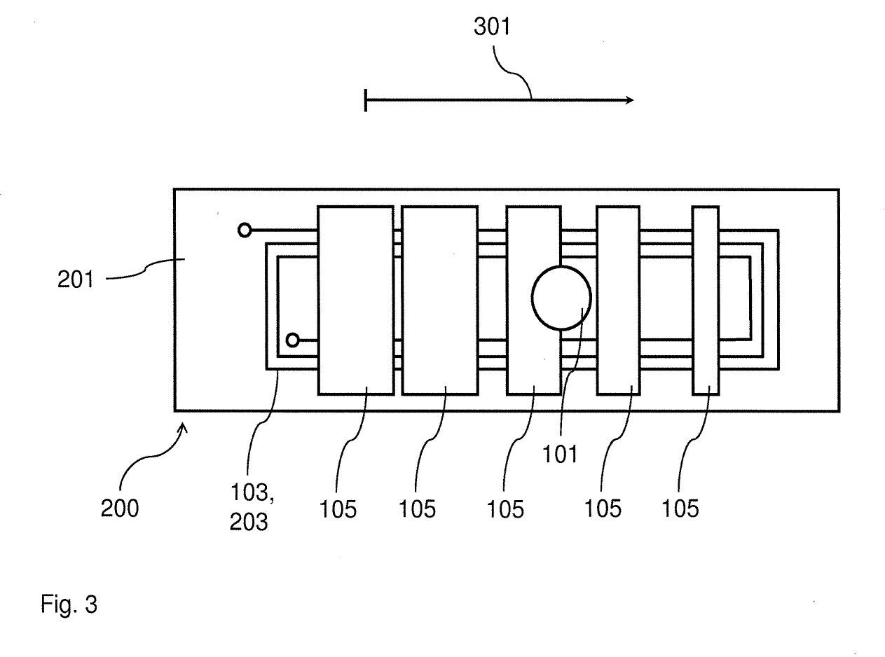

FIG. 3 shows a plan view of a base element 200 for detecting the position of the magnetic object 101 according to one embodiment. The base element 200 comprises the printed circuit board 201 with the conductor track 203 which forms the planar coil 103, and a plurality of magnetizable elements 105. A path 301 is also depicted.

The position of the magnetic object 101, such as a magnet, along the path 301, such as a path s, can be measured. For this purpose, a planar coil 103 formed from the conductor track 203 on the printed circuit board 201 can be arranged along the path 301. The plurality of magnetizable elements 105, such as ferromagnetic elements, are distributed above the planar coil 103 and the printed circuit board 201 along the path 301. The arrangement and dimensions of the plurality of magnetizable elements 105 may cause a dependence of the inductance of the planar coil 103, such as an inductance L, on the position of the magnetic object 101, such as a magnet, along the path 301. This function may arise as a result of the non-uniform distribution of the plurality of magnetizable elements 105 along the path 301. Although the layout of the planar coil 103 along the path 301 does not have any variation in terms of the number and geometry of the conductor track 203, the inductance per unit length of the planar coil 103 dL(s) may be dependent on the path 301 as a result of the plurality of magnetizable elements 105, where L denotes the inductance of the planar coil 103 and the path 301 is parameterized by the parameter s. At locations along the path 301 at which the respective magnetizable element 105 is wide and is at a short distance from the respective adjacent magnetizable elements 105, dL(s) may be high, and is conversely low. Therefore, portions of the planar coil 103 to the left of the image center may have a higher portion of the total inductance L of the planar coil 103. If the magnetic object 101, such as a magnet, is removed, the maximum inductance L of the planar coil 103 can be achieved. If it is on the right, only a slight influence on the inductance L of the planar coil 103 can be exerted as a result of the saturation of the narrow magnetizable elements 105. In contrast, if it is on the left, the saturation of the wide magnetizable elements 105 may have a great influence on the inductance L of the planar coil 103.

According to one embodiment, it is possible to aim for a continuous, monotonous characteristic curve which is as linear as possible. The use of individual discrete magnetizable elements 105 for producing this characteristic curve can therefore preferably be not too roughly selected. The greater the distance of the magnetic object 101, such as a magnet, the greater the range of its field in the sense of saturation of the plurality of magnetizable elements 105 along the path 301 parameterized by the parameter s. The plurality of magnetizable elements 105 can be such that a plurality of said elements are always in the saturation region so that the conditions for a desired characteristic curve are met. The more magnetizable elements 105 used for this purpose, the better. An advantageous design can therefore make extensive use of the minimum web widths and distances available in the process of producing the plurality of magnetizable elements 105. This also makes it possible to reduce eddy currents.

The direction of the flux of the planar coil 103 in the magnetizable elements 105 can run upward and downward from the horizontal central axis or vice versa.

The use of magnetizable elements 105 of different width and distances is only one possible way of obtaining the actual goal, location dependence of the inductance per unit length of the planar coil 103 dL(s). According to one embodiment, the length of the magnetizable elements 105 can also be varied in order to achieve different flux conduction. According to another embodiment, the planar coil 103 may be triangular, for example tapering to a point on the right in the region of high values for the parameter s of the path 301.

According to another embodiment, a planar coil 103 or a separate turn may be provided under each magnetizable element 105, the planar coils 103 or the turns having different numbers of turns and then being able to be connected in series. Planar coils 103 or turns in different layers may be overlapping, or a planar coil 103 or a turn could encompass all magnetizable elements 105, the next could encompass all elements apart from one at the edge until the last planar coil 103 or turn encompasses only the magnetizable element 105 at the other edge.

According to one embodiment, it is possible to provide for a property of the plurality of magnetizable elements 105 to be continuously varied along the path 301. For example, instead of changing the length of the magnetizable elements 105, the plurality of magnetizable elements 105 may be merged with one another. In this case, distances no longer have to be provided. In this case, it can be noted that

1. a particularly high eddy current can flow through the large, extended, conductive body of the merged magnetizable element 105; and/or

2. saturation of the magnetizable element 105 can be located to a lesser extent because the flux conduction in the extended, for example ferromagnetic, body of the magnetizable element 105 is less restricted to the nearby environment of the magnetic object 101 or a magnet. Instead, part of the flux of the magnetic object, such as a magnet, can be conducted over long distances in the body of the magnetizable element 105 and can also saturate regions which are far away from the magnetic object 101, such as a magnet. This property may constitute a considerable distinction with respect to a LIPS system: whereas the latter can presuppose flux conduction in the measuring direction, such conduction may be undesirable here.

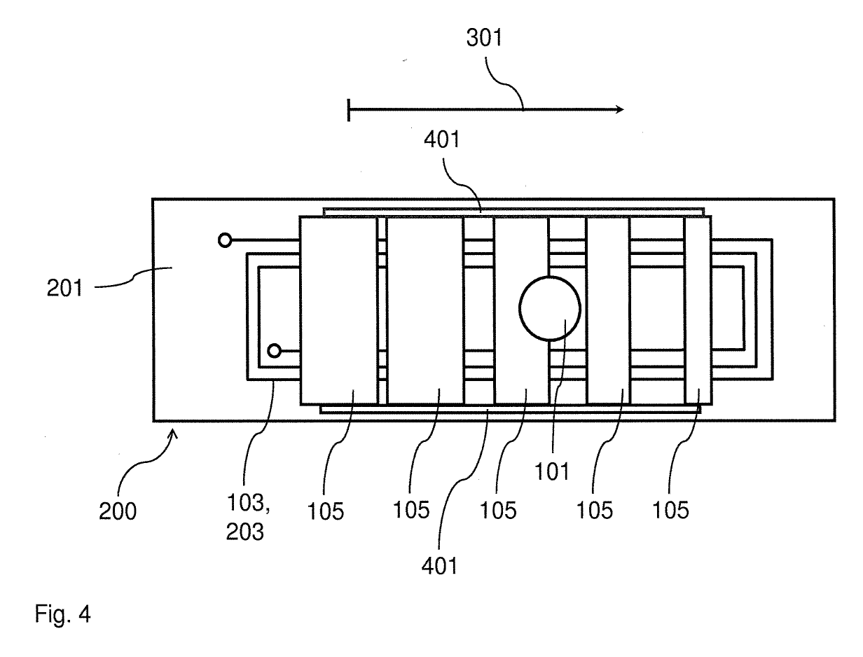

FIG. 4 shows a plan view of a base element 200 for detecting the position of the magnetic object 101 according to another embodiment. The base element 200 comprises the printed circuit board 201 with the conductor track 203 which forms the planar coil 103, and the plurality of magnetizable elements 105 which are mechanically connected to one another via webs 401. The path 301 is also depicted.

FIG. 4 shows how the plurality of magnetizable elements 105 can be combined to form a component without the occurrence of disadvantages. In contrast to the base element 200 shown in FIG. 3, this combination is carried out using the upper and lower webs 401. The influence of this measure on the characteristic curve may remain low because there is no significant flux of the planar coil 103 in the direction of the webs 401. Therefore, it is not important whether or not the magnetic object 101 or the magnet significantly saturates the webs 401. Since the webs 401 are also thin, it is possible for the flux transported through them to not exert any significant influence on the saturation state of the plurality of magnetizable elements 105 which bear the function of the position sensor 100.

The base elements 200 shown in FIGS. 3 and 4 and other arrangements for measuring the position and angle can also be combined in a manner known per se in order to achieve better results. In order to enable differential and/or ratiometric measurements, for example, a base element 200 according to FIG. 3 can be combined with an identical base element 200 in which the arrangement is reflected along the vertical center line and which is arranged or placed beside the base element 200 from FIG. 3. If the signals from these base elements 200 or sensors are denoted A and B, the terms A-B, A/B and (A-B)/(A+B) which are advantageous for suppressing interference and cross-sensitivities can be formed, for example by the processor 107.

### LIST OF REFERENCE SYMBOLS

100 Position sensor

101 Magnetic object

103 Planar coil

105 Magnetizable element

107 Processor

200 Base element

201 Printed circuit board

203 Conductor track

301 Path

401 Web

1. A position sensor for detecting a position of a magnetic object, comprising:
a planar coil;
a magnetizable element which at least partially covers the planar coil and can be magnetized by the magnetic object, as a result of which an impedance of the planar coil can be changed; and
a processor for determining the position of the magnetic object on the basis of the impedance of the planar coil.

2. The position sensor as claimed in claim 1, the magnetizable element being arranged between the planar coil and the magnetic object.

3. The position sensor as claimed in claim 1, the planar coil having a meandering shape, a rectangular shape, a trapezoidal shape or a triangular shape.

4. The position sensor as claimed claim 1, the planar coil being arranged on a printed circuit board.

5. The position sensor as claimed in claim 4, the magnetizable element being arranged on the printed circuit board, by solder or an adhesive bond.

6. The position sensor as claimed in claim 1, the processor being designed to detect a resistance or a reactance of the planar coil.

7. The position sensor as claimed in claim 1, the magnetizable element comprising a ferromagnetic portion.

8. The position sensor as claimed in claim 1, the magnetizable element comprising ferrite, steel, transformer laminate or a highly permeable alloy.

9. The position sensor as claimed in claim 1, the magnetizable element having a rectangular shape, a trapezoidal shape or a triangular shape.

10. The position sensor as claimed in claim 1, having an insulation element which is arranged between the planar coil and the magnetizable element in order to electrically insulate the planar coil and the magnetizable element from one another.

11. The position sensor as claimed in claim 1, having a number of distributed magnetizable elements arranged in a row on the planar coil, a distance between two adjacent magnetizable elements of the number of distributed magnetizable elements increasing or decreasing along the row.

12. The position sensor as claimed in claim 1, having a number of distributed magnetizable elements arranged in a row on the planar coil, a length or a width of the magnetizable elements of the number of distributed magnetizable elements increasing or decreasing along the row.

13. The position sensor as claimed in claim 1, having a number of distributed magnetizable elements arranged in a row on the planar coil, the magnetizable elements of the number of distributed magnetizable elements being mechanically connected to one another a web.

14. The position sensor as claimed in claim 1, having a number of distributed magnetizable elements arranged in a row on the planar coil, the number of distributed magnetizable elements being arranged on a carrier film.

15. The position sensor as claimed in claim 1, the processor also being designed to determine the position of the magnetic object on the basis of an eddy current loss value of the planar coil.

16. The position sensor as claimed in claim 2, the planar coil having a meandering shape, a rectangular shape, a trapezoidal shape or a triangular shape.
